(19) United States
(12) Patent Application Publication
(10) Pub. No.: US 2003/0085811 A1
(43) Pub. Date: May 8, 2003

(54) Safe exit homing alarm and method

(76) Inventor: Michael Fitzpatrick, New Orleans, LA (US)

Correspondence Address: Duane Morris LLP, 1667 K Street, N.W., Suite 700, Washington, DC, 20006, US

(21) Appl. No.: 09/985,659

(22) Filed: Nov. 5, 2001

(51) Int. Cl. G08B 17/10

(52) U.S. Cl. 340/628

(57) ABSTRACT

An alarm which emits an audible alarm upon the detection of a hazardous condition and which discontinues or changes a characteristic of the audible alarm upon detection that it is unsafe to use the exit with which the alarm is associated. Methods are also disclosed.

### BACKGROUND OF THE INVENTION

The present invention relates to an alarm system and method and more particularly to an alarm system on which persons may home to exits which are safe to use.

While applicable to hazardous conditions of various types, the present invention may perhaps be most readily understood in the context of a fire. Fire alarms are in common use in enclosed areas of all types of structures, e.g. homes, office buildings, ships, etc. Exits from such enclosed areas are generally marked with elevated “EXIT” signs attached to the wall over the exit or suspended from the ceiling so that they may be seen from a distance to direct the occupant to the exit. Such signs may be provided with strobe or high intensity lights to increase the likelihood that they can be seen once smoke begins to accumulate in the space.

However, and as is well known, the human eye reacts to smoke by involuntary closure and visual directions to exits are often ineffective. Audible alarms are also conventional, but often are ineffective as direction indicators because they compete with the alarms associated with other exits within the space, particularly in emergencies when the persons in need of guidance may panic and/or become disoriented from the smoke and/or the alarms.

Even where persons blinded by smoke and in need of directional guidance can distinguish the direction to an exit from an audible alarm, known alarms to not indicate whether or not it is safe to use the exit and attempts to use the exit may have disastrous consequences not only to the persons attempting to use the exit but to the area and others therein.

It is accordingly an object of this invention to provide a novel alarm system and method which obviates many of the deficiencies in known alarm systems and which has the capability of audibly guiding persons within an enclosed space to a exit which is safe to use.

These and many other objects and advantages of the present invention will be readily apparent to one skilled in the art to which the invention pertains from a review of claims, the appended drawings and the following detailed description of preferred embodiments.

### BRIEF DESCRIPTION OF THE DRAWINGS

FIG. 1 is a pictorial representation of one embodiment of the present invention.

FIG. 2 is a schematic diagram of the embodiment of FIG. 1.

### DESCRIPTION OF PREFERRED EMBODIMENTS

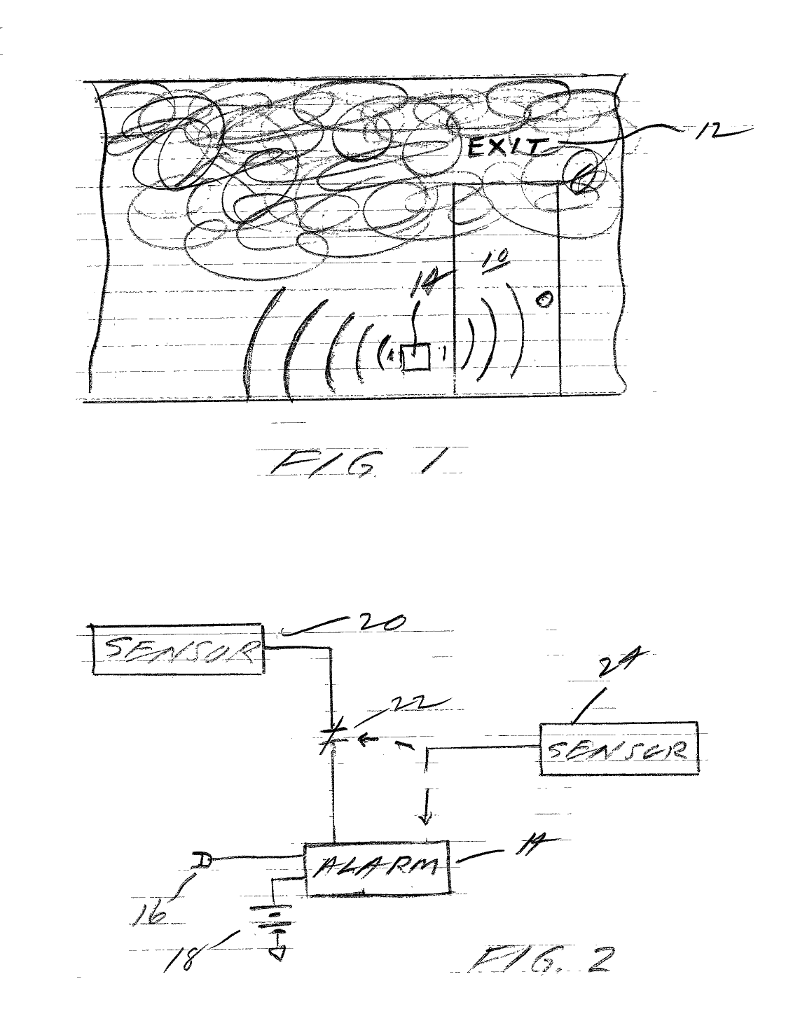

FIG. 1 illustrates one embodiment of an alarm in the environment of a hallway or corridor, it being understood that the alarm has utility in any enclosed space having exits through which persons must leave to avoid a potentially unsafe condition in the space.

With reference to FIG. 1, the exits 10 to a space are generally marked with elevated “EXIT” signs 12 so that they may be seen from a distance. Such signs 12 may be provided with strobe or high intensity lights to increase the likelihood that they can be seen once smoke begins to accumulate in the space, and often include audible alarms.

As shown in FIG. 1, the alarm 14 is desirably located low on the wall adjacent an exit and may include any suitable visual indicators. The alarm my be mounted into or on the wall with any necessary electrical wiring internal or external to the wall.

As schematically illustrated in FIG. 2, the alarm 14 may be connected by any suitable conventional means to a source of alternating current power and be provided with a conventional auxiliary power supply such as the illustrated battery 18 so that the alarm is operable in the event of failure of the a.c. power supply.

One or more conventional sensors 20 may be provided in the immediate vicinity of the exit 10 or located at some distance therefrom to sense an alarm condition, e.g. temperature, radiant energy or smoke. Once an alarm condition is sensed, the alarm 14 may provide an appropriate audible alarm. It is desirable that the audible alarm be distinctive, e.g. a warble or pulsed, to indicate not only the existence of the alarm condition but also the direction to the exit 10. Obviously, it is desirable that the particular sound be internationally accepted so that individuals will be able to appropriately respond thereto anywhere in the world.

In one embodiment, the sensor 20 or the communication from the sensor 20 to the alarm may be disabled by the opening of a suitable conventional normally closed switch 22 responsive, e.g., to a sensor 24 located proximate to the exit 10. In this manner, the audible alarm may be effectively interrupted by the sensor 24 when, e.g., the temperature adjacent the exit reaches an unsafe threshold. The sensor 24 and contacts 22 may be integrated and form a conventional thermostat controlled switch, and it may be convenient to locate the thermostat 24 inside the alarm 14.

In an alternative embodiment also illustrated in FIG. 2, the sensor 24 may be any suitable conventional sensor located on the near or far side of the wall through which the exit 10 provides passage.

As an alternative, the alarm may be provided with two noise generators having distinctive audible alarms. The sensor 24 may be operatively connected to the second of the noise makers so that concurrent alarms may be used as an indication that it is not safe to use the exit10. The two noise makers may be independent, or connected by any suitable conventional circuit so that the first noise maker is disabled by or at the same time as the second noise maker is enabled.

In a typical operation, the alarm of the present invention may be initiated by a smoke detector to provide an indication to a hotel guest or office worker that there is a fire somewhere in the building, and that evacuation should proceed through the available exits. Where, for example, the stairway on the other side of the exit is filled with smoke or flames, the second alarm will be triggered to disable the first alarm and/or to provide an alternative audible indication that the exit is not safe to use.

While preferred embodiments of the present invention have been described, it is the be understand that the embodiments described are illustrative only, and that the scope of the invention is to be defined solely by the appended claims when accorded a full range of equivalents, many variations and modifications naturally occurring to the skilled in the art from a perusal of this application.

What is claimed is:

1. In an alarm system adapted for connection to an alternating current power supply and having a direct current power supply operable in the absence of power from the alternating current power supply, a condition sensor and an alarm responsive to the condition sensor for providing an audible indication that a first predetermined threshold in the sensed condition has been reached, the improvement comprising means for modifying the audible indication as an indication that a second predetermined threshold in the sensed condition has been reached.

2. The alarm system of claim 1 wherein the modification is silence.

3. The alarm system of claim 1 wherein the modification is a distinctive change in the frequency of the audible indication.

4. The alarm system of claim 1 wherein the condition is smoke.

5. The alarm system of claim 1 wherein the condition is temperature.

6. An fire alarm system selectively positioned proximate to an exit comprising:
means for generating sound;
means for sensing a first unhealthy condition;
means for sensing a second unhealthy condition;
means for selectively connecting said sound generating means and said two sensing means to a source of alternating current power;
means for operatively connecting said sound generating means and said two sensing means to a source of direct current power in the absence of the connection of said sound generating means to said source of alternating current power to thereby enable the operation of said sound generating means and said sensing means in the absence of alternating current power,
said sound generating means being responsive to said sensing means to provide a first sound in response to the sensing of the first unhealthy condition and a second sound distinct from the first sound in response to the sensing of the second unhealthy condition,
so that persons hearing the first sound will be informed that an unhealthy condition exists and can use the first sound as an aid in locating the associated exit, and
so that persons hearing the second sound will be informed that a condition exists at the associated exit which is so unhealthy that it is unsafe to use the associated exit.

7. The alarm system of claim 6 wherein said second sound is silence.

8. The alarm system of claim 6 wherein said sounds differ in frequency.

9. The alarm system of claim 6 wherein said sounds are pulses and differ in pulse repetition rate.

10. The alarm system of claim 6 wherein the first unhealthy condition is smoke.

11. The alarm system of claim 6 wherein the second unhealthy condition is temperature.

12. The alarm system of claim 6 wherein both of said sound generating means are located adjacent the floor.

13. A method of guiding persons within a confined space having plural exits to a safe exit in the event of a fire comprising:
(a) detecting the existence of a fire;
(b) providing a first distinctive sound from a position adjacent at least one of the plural exits to aurally guide persons within the space to an exit;
(c) detecting the existence of an unsafe condition at one of the plural exits: and
(d) providing a second distinctive sound from a position adjacent the exit with the unsafe condition to thereby inform persons within the space of the danger of using the exit with the unsafe condition.

14. The method of claim 13 wherein the second sound is silence.

15. The method of claim 13 wherein the existence of a fire is detected by the detection of smoke and the existence of the unsafe condition is detected of heat.

16. A method of guiding persons within a confined space having plural exits to a safe exit in the event of a hazardous condition within the space comprising:
(a) detecting the existence of a hazardous condition within the space;
(b) providing a distinctive sound from an alarm adjacent each of the plural exits to aurally guide persons within the space to one of the plural exits;
(c) detecting the existence of an unsafe condition in proximity to a first one of the plural exits: and
(d) modifying the distinctive sound from the alarm adjacent the first exit to thereby inform persons within the space of the danger of using the first exit
so that persons within the space can select one of the plural exits other than the first exit.
